(19) United States
(12) Patent Application Publication
(10) Pub. No.: US 2005/0079858 A1
(43) Pub. Date: Apr. 14, 2005

(54) Method and apparatus for restricting media communication in a communication network

(76) Inventors: Eric C. Rosen, Solana Beach, CA (US); Beth Ann Brewer, La Mesa, CA (US); Douglas M. Crockett, San Diego, CA (US)

Correspondence Address: Qualcomm Incorporated;Patents Department, 5775 Morehouse Drive, San Diego, CA, 92121-1714, US

(21) Appl. No.: 10/683,642

(22) Filed: Oct. 9, 2003

(51) Int. Cl. H04Q 7/20

(52) U.S. Cl. 455/411; 455/414.1

(57) ABSTRACT

The disclosed embodiments provide methods and apparatus for restricting media communication in a wireless communication network. The method includes receiving an indication from an originator for setting up a media communication session with at least one target, applying at least one media communication restriction, and sending a request for setting up the media communication if the originator is allowed to have media communication with at least one of the targets. The media communication restriction includes inbound and/or outbound media communication restriction. The media communication restriction also includes carrier-level media communication restrictions and/or user-level media communication restrictions.

### FIELD

The present invention relates to point to point or point to multi-point communications systems. More specifically, the present invention relates to methods and apparatus for restricting inbound and/or outbound media communication for users within a group wireless communication network.

### BACKGROUND

A class of wireless services intended for quick, efficient, one-to-one or one-to-many (group) communication has existed in various forms for many years. In general, these services have been half-duplex, where a user presses a “push-to-talk” (PTT) button on a phone/radio to initiate a group communication. If granted the floor, the talker then generally speaks for a few seconds. After the talker releases the PTT button, other users who are available may request the floor. These services have traditionally been used in applications where one person needs to communicate with a group of people, such as field service personnel or taxi drivers, generally known as group communication services.

A service provider (carrier) or an enterprise may have reasons to limit the list of people that a user may communicate with. Users may also need to place restriction on who they receive media from such as blocking the dating group during office hours or parents wanting to restrict the targets that their children may contact.

There is a need, therefore, for mechanisms to selectively restrict inbound and/or outbound media communication for users in a group wireless communication network.

### SUMMARY

The disclosed embodiments provide novel and improved methods and apparatus for restricting media communication in a wireless communication network. In one aspect, the method provides for restricting media communication in a wireless communication network includes receiving an indication from an originator for setting up a media communication session with at least one target, applying at least one media communication restriction, and sending a request for setting up the media communication if the originator is allowed to have media communication with the target.

In another aspect, the method includes receiving a request from a communication device for setting up a media communication session with at least one target, applying at least one media communication restriction on the target, and sending a media communication announcement to the target if the target is not restricted to receive media communication from the originator.

In another aspect, the method includes receiving a media communication announcement for setting up a media communication session requested by an originator, applying at least one media communication restriction, and sending an acceptance for setting up the media communication if the originator is allowed to have media communication with the target.

In one aspect, an apparatus for restricting media communication in a wireless communication network includes a memory unit, a receiver, a transmitter, and a processor communicatively coupled with the memory unit, the receiver, and the transmitter. The processor is capable of carrying out the above-mentioned methods.

### BRIEF DESCRIPTION OF THE DRAWINGS

The features and advantages of the present invention will become more apparent from the detailed description of the embodiments set forth below:

FIG. 1 illustrates a group communications system;

FIG. 2 illustrates how several communication devices interact with a group communication server;

FIG. 3 illustrates one embodiment for an infrastructure for implementing various disclosed embodiments; and

FIG. 4 illustrates a flow diagram for establishing a restricted media communication session.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

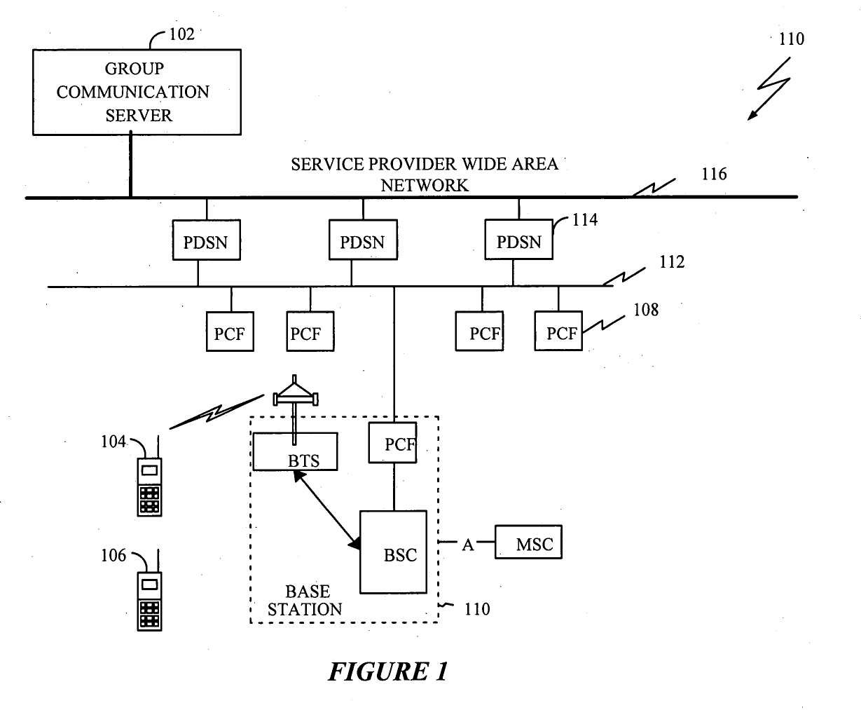

FIG. 1 illustrates a functional block diagram of a group communication system 100, for implementing one embodiment. Group communication system 100 is also known as a push-to-talk (PTT) system, a net broadcast service (NBS), a dispatch system, or a point-to-multi-point communication system. In one embodiment, group communication system 100 includes a group communication server (GCS) 102, which may be deployed in either a centralized deployment or a regionalized deployment. Group communication server 102 may be implemented as known in the art, including one or more processor, one or more memory units, and input/out hardware and software modules for various media communications, e.g., IP media communication.

Group communication devices (CDs) 104 and 106, which may be deployed such as CDMA (e.g., cdma2000) handsets, for example, may request packet data sessions using a data service option. Each CD may use the session to register its Internet protocol (IP) address with the group communication server to perform group communication initiations. In one embodiment, group communication server 102 is connected to the service provider's packet data service nodes (PDSNs) through service provider's network 116. CDs 104 and 106, upon requesting packet data sessions from the wireless infrastructure, may have IP connectivity to group communication server 102 through the PDSNs 114. Each PDSN may interface to a base station controller (BSC) through a packet control function (PCF) 108 and a network 112. The PCF may be co-located with the BSC within a base station (BS) 110.

A packet data service node may fall in one of several states, e.g., active or connected state, dormant state, and null or inactive state. In the active or connected state, a active traffic channel exists between the participating CD and the BS or BSC, and either side may send data. In the dormant state, no active traffic channel exists between the participating CD and the BSC, but a point-to-point protocol (PPP) link is maintained between the participating CD and the PDSN. In the null or inactive state, there is no active traffic channel between the participating CD and the BSC, and no PPP link is maintained between the participating CD and the PDSN.

Each one of CDs 104 and 106 may request packet data sessions. As part of establishing a packet data session, each CD may be assigned an IP address. Each CD may perform a registration process to notify group communication server 102 of the CD's IP address. Registration may be performed using an IP protocol, such as session initiation protocol (SIP) over user datagram protocol (UDP). The IP address of a CD may be used to contact the CD when the corresponding user is invited into or informed of a group communication.

Once a group communication is established, CDs 104 and 106 and group communication server 102 may exchange media and signaling messages. In one embodiment, media may be exchanged between the participating CDs and the group communication server by using real-time protocol (RTP) over UDP. The signaling messages may also be exchanged by using a signaling protocol over UDP.

Group communication system 100 performs several different functions in order to operate group communication services. The functions that relate to the user side include user registration, group communication initiation, group communication termination, sending messages to group participants, late join to a group communication, talker arbitration, adding members to a group, removing members from a group, un-registering a member, and user authentication. The functions that relate to system preparation and operation include administration and provisioning, scalability, and reliability.

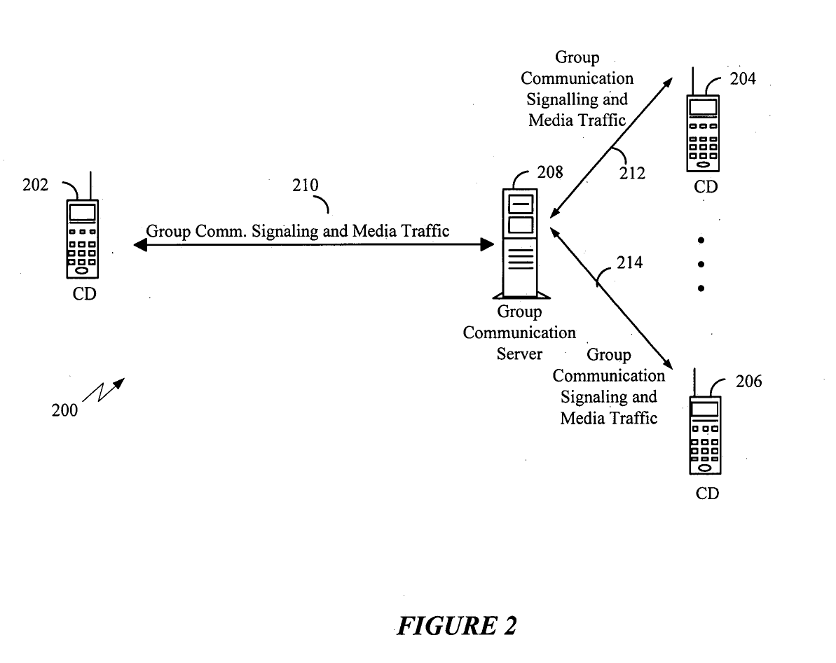

FIG. 2 illustrates a group communication arrangement 200 for showing how CDs 202, 204, and 206 interact with a group communication server 208. Multiple group communication servers may be deployed as desired for large-scale groups. A user may input her desire to a CD 202, 204, 206 to initiate a communication session for exchanging communication media, e.g., data, voice, image, and/or video, with one or more CDs. In one embodiment, the user may first invite the target users(s) before starting to communicate media, by pushing an “invite” or a PTT button on a CD.

In FIG. 2, when CD 202 has permission to transmit media to other members of the group, CD 202 is known as the originator and may transmit media over an established channel. When CD 202 is designated as the originator, the remaining participants, CD 204 and CD 206, may not be permitted to transmit media to the group. Accordingly, CD 204 and CD 206 are designated as targets. As described above, CDs 202, 204, and 206 are connected to group communication server 208, using at least one channel. In one embodiment, channels 210, 212, and 214 may include a session initiation protocol (SIP) channel, a media-signaling channel, and a media traffic channel.

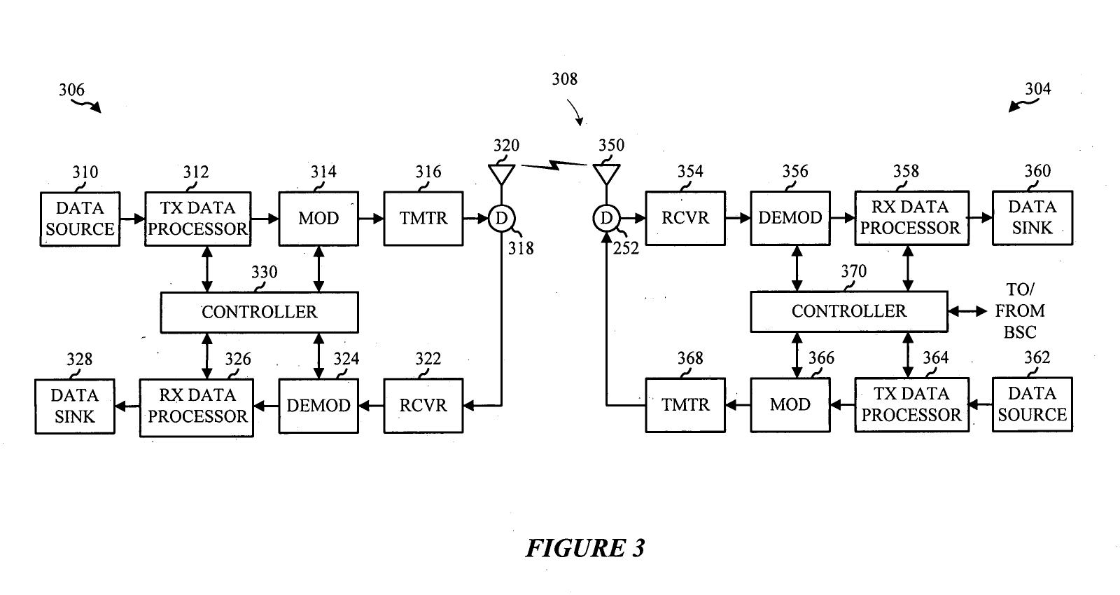

FIG. 3 is a simplified block diagram of one embodiment of an infrastructure including a base station/base station controller (BS/BSC) 304 and a communication device 306, which are capable of implementing various disclosed embodiments. For a particular media communication, voice, data, packet data, and/or alert messages may be exchanged between BS/BSC 304 and communication device 306, via an air interface 308. Various types of messages may be transmitted, such as messages used to establish a communication session between the base station and the communication device, registration and paging messages, and messages used to control a data transmission (e.g., power control, data rate information, acknowledgment, and so on). Some of these message types are described in further detail below.

For the reverse link, at communication device 306, voice and/or packet data (e.g., from a data source 310) and messages (e.g., from a controller 330) are provided to a transmit (TX) data processor 312, which formats and encodes the data and messages with one or more coding schemes to generate coded data. Each coding scheme may include any combination of cyclic redundancy check (CRC), convolutional, turbo, block, and other coding, or no coding at all. The voice, packet data, and messages may be coded using different schemes, and different types of messages may be coded differently.

The coded data is then provided to a modulator (MOD) 314 and further processed (e.g., covered, spread with short PN sequences, and scrambled with a long PN sequence assigned to the communication device). The modulated data is then provided to a transmitter unit (TMTR) 316 and conditioned (e.g., converted to one or more analog signals, amplified, filtered, and quadrature modulated) to generate a reverse link signal. The reverse link signal is routed through a duplexer (D) 318 and transmitted via an antenna 320 to BS/BSC 304.

At BS/BSC 304, the reverse link signal is received by an antenna 350, routed through a duplexer 352, and provided to a receiver unit (RCVR) 354. Alternatively, the antenna may be part of the wireless operator network, and the connection between the antenna and the BS/BSC may be routed through the Internet. BS/BSC 304 may receive media information and alert messages from communication device 306. Receiver unit 354 conditions (e.g., filters, amplifies, down converts, and digitizes) the received signal and provides samples. A demodulator (DEMOD) 356 receives and processes (e.g., despreads, decovers, and pilot demodulates) the samples to provide recovered symbols. Demodulator 356 may implement a rake receiver that processes multiple instances of the received signal and generates combined symbols. A receive (RX) data processor 358 then decodes the symbols to recover the data and messages transmitted on the reverse link. The recovered voice/packet data is provided to a data sink 360 and the recovered messages may be provided to a controller 370. Controller 370 may include instructions for receiving and sending information, receiving and sending responses to messages, identifying the targets, locating the targets, determining restrictions imposed on the originator and the targets, determining whether the originator and/or the targets are registered in the group communication system and/or whether at least one target accepts to receive media, and buffering media. The processing by demodulator 356 and RX data processor 358 are complementary to that performed at remote access device 306. Demodulator 356 and RX data processor 358 may further be operated to process multiple transmissions received via multiple channels, e.g., a reverse fundamental channel (R-FCH) and a reverse supplemental channel (R-SCH). Also, transmissions may be simultaneously from multiple communication devices, each of which may be transmitting on a reverse fundamental channel, a reverse supplemental channel, or both.

On the forward link, at BS/BSC 304, voice and/or packet data (e.g., from a data source 362) and messages (e.g., from controller 370) are processed (e.g., formatted and encoded) by a transmit (TX) data processor 364, further processed (e.g., covered and spread) by a modulator (MOD) 366, and conditioned (e.g., converted to analog signals, amplified, filtered, and quadrature modulated) by a transmitter unit (TMTR) 368 to generate a forward link signal. The forward link signal is routed through duplexer 352 and transmitted via antenna 350 to remote access device 306. Forward link signals include paging signals.

At communication device 306, the forward link signal is received by antenna 320, routed through duplexer 318, and provided to a receiver unit 322. Receiver unit 322 conditions (e.g., down converts, filters, amplifies, quadrature modulates, and digitizes) the received signal and provides samples. The samples are processed (e.g., despreaded, decovered, and pilot demodulated) by a demodulator 324 to provide symbols, and the symbols are further processed (e.g., decoded and checked) by a receive data processor 326 to recover the data and messages transmitted on the forward link. The recovered data is provided to a data sink 328, and the recovered messages may be provided to controller 330. Controller 330 may include instructions for receiving and sending information, receiving and sending responses to messages, imposing restrictions on media communication traffic, determining the restriction imposed on the originator and/or the targets, buffering media, transmitting media to a group communication server, and granting permission to the originator to deliver media.

A service provider (carrier), an enterprise, or any other entity may have reasons to limit the list of people that a user may communicate with. Users may also need to place restriction on who they receive media from such as blocking the dating group during office hours or parents wanting to restrict the targets that their children may contact.

In one embodiment, media communication restrictions are configurable by both the carrier and the user, among other entities capable of defining media communication restriction. In one embodiment, the carrier has the ultimate authority over some or all restrictions. Carrier-level restrictions provide the ability for the carrier to define for each user a subset of the carrier's user base within which communication is allowed. User-level restrictions provide the ability for each user to define additional limitations on the communication between the user and the subset of users defined by the carrier-level restrictions.

In one embodiment, media communication restrictions may be specified as:
ALLOW—communication is allowed but not required, i.e. ALLOW may be overridden by a DENY
ALLOW_ALWAYS—communication is allowed and required, i.e. ALLOW_ALWAYS may not be overridden by a DENY
DENY—communication is not allowed.

As a default, communication may be allowed between all users in all domains, which may be viewed as an implicit “ALLOW all” entry as the first item in the carrier-level restriction list, enabling communication between all endpoints.

Call restrictions may be applied as two independent ordered lists—one defined by the carrier and the other defined by each user. The ordering of the list may imply that the restriction entries at the end of the list override the entries at the beginning of the list. In addition, carrier-level restrictions may override the user-configured restrictions.

Each media restriction entry may specify one of the following two types:
ALLOW communication with a specific user address
ALLOW communication within a group domain
DENY communication with a specific user address
DENY communication within a group domain
ALWAYS_ALLOW (require) communication with a specific user address
ALWAYS_ALLOW (require) communication within a group domain.

For incoming media communications traffic, the target's restrictions may be applied to the originator's user address only. For outgoing media communications traffic, the originator's restrictions may be applied on each entry in the target list specified in the media communication request. Each entry in the target list may be an ad-hoc group address, a chat-room address, or a user address. If a closed group address or closed chat-room address is specified, the restrictions may be applied to the group address only, and not to the members of the group.

In one embodiment, media restriction entries has the following syntax:
<token_to_match, type, level, direction>
where:
token_to_match={user address, domain, or all (specified by the literal ‘*’)}
type={DENY, ALLOW, or ALLOW_ALWAYS}
level={carrier or user}
direction={inbound or outbound}.

When a domain is specified as the token_to_match, the domain is compared against the domain portion of each address to determine if it is included in the domain portion of the group address. This allows the restriction to specifically address a single domain or a domain and all of its sub-domains. When a user address is specified as the token_to_match, the user address is compared against the entire user address to determine if there is an exact match.

Carrier-level restrictions may be configured at the time of user subscription and change infrequently during the duration of the subscription. User-level call restrictions may be configured by the user via an option on the user's CD. The anticipation is that user-level restrictions may change frequently.

Since carrier-level restrictions define the limitations within which user-level restrictions may be further defined, the carrier-level restrictions are delivered to the user's CD in order to provide the configuration of user-level restriction.

Carrier-level and user-level media restrictions may be applied in two areas of the media communication setup process. Outbound media restrictions placed on the originator are applied at one of the initial steps of media communication setup. Inbound media communication restrictions placed on each target are applied when the group communication sever (GCS) is attempting to contact each target.

In one embodiment, outbound media communication restrictions are applied on outgoing calls only. Provided the carrier-level restrictions do not change frequently and the carrier-level restrictions have already been delivered to the user's CD, outbound restrictions are applied on the user's CD. Applying the outbound restrictions on the user's CD prior to each media communication origination eliminates the need to send a media communication setup request to the GCS for a media communication that cannot be established due to outbound restrictions. By eliminating these messages prior to using infrastructure resources to send a media communication setup request, a savings in the load on the infrastructure is gained, e.g, eliminating a single media communication setup request may result in a savings of a minimum of four GCS messages sent on the overhead channels and traffic channel.

In one embodiment, the inbound restrictions are applied on incoming calls only. Since the user-level restriction may change frequently, delivering and storing user-level restrictions on the server upon every update would add significant load to the system. Therefore, inbound user-level restrictions may be stored on the user's CD only. This results in the need to apply all (inbound and outbound) user level call restrictions on the user's CD only.

Applying carrier-level restrictions on the GCS prior to each target being contacted eliminates the need to send a media communication announcement to the target for a media communication that cannot be established due to inbound restrictions levied against the user. By eliminating these messages prior to using infrastructure resources to send a communication announcement message, a savings in the load on the infrastructure may be recognized. Eliminating a single media communication announcement may result in a savings of a minimum of two GCS messages sent on the overhead channels and traffic channel origination messages.

Both the user's CD and the group communication server (GCS) may play a role in the enforcement of media communication restrictions. The restrictions imposed on an originator, both at carrier and user levels, are applied at the originator's CD prior to sending the communication setup request to the GCS. The carrier-level restrictions for each target are applied at the GCS, while the user (target)-level restrictions are applied when the communication announcement reaches the target's CD.

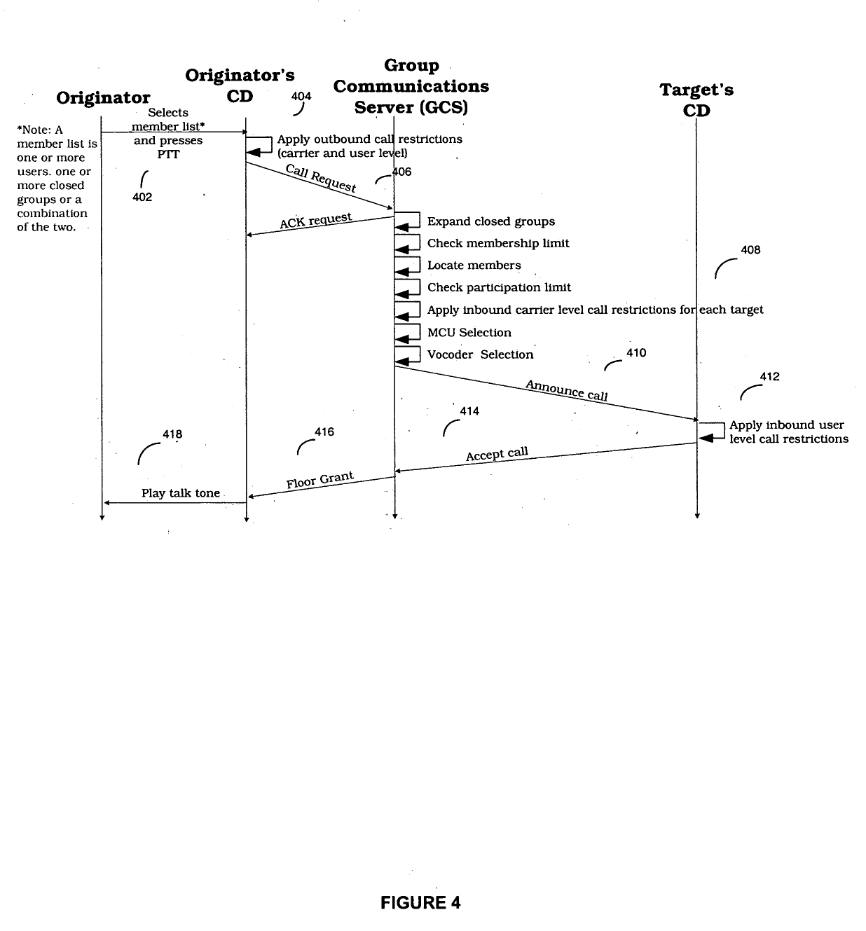

FIG. 4 illustrates a process for establishing a restricted media communication session, according to one embodiment. After the originator selects a member list and presses the PTT button on his or her CD, as shown in step 402, the originator's CD applies the outbound restrictions to all targets specified in the communication request, as shown in step 404. The targets may be specified by either users addresses and/or predefined group addresses. In order to specify a restriction against a predefined group, the domain portion of the group address is specified in the <token_to_match> field of the restriction entries. In one embodiment, only the group address is checked against the restrictions, and each member in the group's membership list may not be checked against the restrictions.

If the originator's CD detects one or more restrictions that deny media communication establishment, the media communication setup is failed and the user is notified accordingly. If the user is allowed to communicate with all targets specified in the group's membership list, a “call request” is sent to the GCS or a regional dispatcher (RD), in step 406. Upon receiving the call request, the GCS or the regional dispatcher expands any closed groups included in the request to a list of users. Once the target list has been expanded to contain the user addresses, the GCS or the regional dispatcher verifies that the target list does not exceed the membership limit for the call type. After the regional dispatcher verifies the call is within the specified limit, the regional dispatcher locates all of the target users. Based on the number of located targets, the GCS or the regional dispatcher verifies that the call is within the specified participation limit for the call type. If the participation limit has not been exceeded, the GCS or the regional dispatcher applies the inbound carrier-level restrictions for each target to the originator's user address, as shown in step 408.

If one or more targets are not allowed to communicate with the originator, the call proceeds without those targets being contacted. The GCS or the regional dispatcher may not modify the membership list of the call; therefore, every time the call is re-established the target's call restrictions are applied, and if the communication is still denied, the target is not contacted anymore.

The GCS or the regional dispatcher selects the vocoder and media control unit (MCU) using the reduced target list, and the GCS or the regional dispatcher sends out call announcements, as shown in step 410, to all targets in the reduced target list. When a target's CDt receives the call announcement, the target's CD applies the user-level inbound restrictions to the originator's user address, as shown in step 412, to determine if media communication is allowed. If communication is allowed, the target's CD acknowledges the call announcement, as shown in step 414, accepting the call. Otherwise, if communication is not allowed, the target's CD acknowledges the call announcement by rejecting the call.

Upon receipt of one or more acknowledgements accepting the call, the GCS or the regional dispatcher sends a “floor grant” message to the originator's CD, as shown in step 416, indicating the communication with one or more targets has been established, and permission to talk may be granted to the originator, as shown in step 418.

In one embodiment, prior to applying restrictions, the media communication restriction configuration system may not allow the user to add:
A DENY restriction at the user level that conflicts with an ALLOW_ALWAYS restriction at the carrier level
An ALLOW restriction that conflicts with a DENY restriction at the carrier level.

In one embodiment, carrier-level restrictions are applied first, starting from the last entry in the restriction list and proceeding until there is a match on an entry that specifies a DENY or until all entries in the restriction list have been evaluated. If a match on an entry that specifies an ALLOW_ALWAYS is found at the carrier level, all other restrictions against that address are ignored. If a match on an entry that specifies ALLOW is found at the carrier level, the user level restrictions are checked to determine if there is a match on an entry that specifies a DENY for that address. If a match occurs on either a carrier-level or a user-level DENY, the algorithm is aborted and the call is denied.

In one embodiment, for outbound media communication traffic:
For each target entry in the call setup request,
For each carrier-level restriction entry with direction field set to “outbound,”
If target entry matches carrier-level restriction “token_to_match” field,
If the type field is set to ALLOW_ALWAYS,
Proceed to next target nntry
Else if the type field is set to DENY,
Exit algorithm and return “call denied”
Else (the type field is set to ALLOW)
For each user-level restriction entry with direction field set to “outbound”
If target entry matches user-level restriction token_to_match field
If the type field is set to DENY
Exit algorithm and return “call denied”
Else
Proceed to previous user-level restriction entry
Proceed to next target entry
Else
Proceed to previous carrier-level restriction entry.

For inbound media communication traffic, the following algorithm is enforced on the GCS:
For each carrier-level restriction entry with direction field set to “inbound”
If originator's address matches carrier-level restriction “token_to_match”
If the type field is set to ALLOW or ALLOW_ALWAYS
Exit algorithm and return “call allowed” (call announcement is sent)
Else (the type field is set to DENY)
Exit algorithm and return “call denied” (call announcement is not sent)
Else
Proceed to previous carrier-level restriction entry.

When the call announcement is received at the user's CD the following algorithm is enforced:
For each user-level restriction entry with direction field set to “inbound”
If originator's address matches user-level restriction “token_to_match” field
If the type field is set to DENY
Exit algorithm and return “call denied”
Else
Proceed to previous user-level restriction entry
Exit algorithm and return “call allowed.”

When additional configuration levels of restrictions are added to the above algorithm, which may result in additional call restriction lists for each level of configuration added between the carrier level and the user level, the enforcement algorithm may be modified to deal with the intermediate lists.

Carrier-level restrictions may be configured using an interface into the carrier provisioning system. The carrier provisioning system is responsible for the distribution of the carrier-level restrictions to the GCS components and the CDs that are impacted by the change. User-level restrictions may be configured using an interface on the user's CD. The user is allowed to specify restrictions relating to user address or domains. The configuration application on the user's CD may verify the user-level restrictions do not attempt to override or contradict the carrier-level restrictions for that user.

In order for changes to the carrier-level restrictions for a particular user to be applied to a group communication involving the user in a timely fashion, the carrier notifies the GCS that changes have occurred. This may be done through two mechanisms. First, the carrier writes the new restrictions to a user and/or group database. If the user is not registered, the user's new restrictions are loaded upon the next registration. Second, the carrier notifies a home dispatcher (HD) that the user's restrictions have changed. The HD determines if the user is registered within the local carrier network. If the user is registered, the HD notifies the regional dispatcher (RD) that the uer's call restrictions need to be reloaded from the user and/or group database.

Carrier-level restrictions may also be distributed to a user's CD via the application configuration access protocol (ACAP) provisioning interface. The user' CD is notified that new restriction updates are available upon the next registration of the user, after the restriction update has occurred.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

1. A method for restricting media communication in a wireless communication network, the method comprising:
receiving an indication from an originator for setting up a media communication session with at least one target;
applying at least one media communication restriction; and
sending a request for setting up the media communication if the originator is allowed to have media communication with the target.

2. The method of claim 1, wherein said applying at least one media communication restriction includes applying at least one outbound media communication restriction.

3. The method of claim 2, wherein said applying at least one media communication restriction includes applying at least one carrier-level media communication restriction.

4. The method of claim 2, wherein said applying at least one media communication restriction includes applying at least one user-level media communication restriction.

5. A computer-readable medium embodying codes for implementing a method for restricting media communication in a wireless communication network, the method comprising:
receiving an indication from an originator for setting up a media communication session with at least one target;
applying at least one media communication restriction; and
sending a request for setting up the media communication if the originator is allowed to have media communication with the target.

6. The medium of claim 5, wherein said applying at least one media communication restriction includes applying at least one outbound media communication restriction.

7. The medium of claim 6, wherein said applying at least one media communication restriction includes applying at least one carrier-level media communication restriction.

8. The medium of claim 6, wherein said applying at least one media communication restriction includes applying at least one user-level media communication restriction.

9. An apparatus for restricting media communication in a wireless communication network, comprising:
means for receiving an indication from an originator for setting up a media communication session with at least one target;
means for applying at least one media communication restriction; and
means for sending a request for setting up the media communication if the originator is allowed to have media communication with the target.

10. The apparatus of claim 9, wherein said means for applying at least one media communication restriction includes means for applying at least one outbound media communication restriction.

11. The method of claim 10, wherein said means for applying at least one media communication restriction includes means for applying at least one carrier-level media communication restriction.

12. The method of claim 10, wherein said means for applying at least one media communication restriction includes means for applying at least one user-level media communication restriction.

13. An apparatus for restricting media communication in a wireless communication network, comprising:
a memory unit;
a receiver;
a transmitter; and
a processor coupled to the memory unit, the receiver, and the transmitter, the processor being capable of:
receiving an indication from an originator for setting up a media communication session with at least one target;
applying at least one media communication restriction; and
sending a request for setting up the media communication if the originator is allowed to have media communication with the target.

14. The apparatus of claim 13, wherein said applying at least one media communication restriction includes applying at least one outbound media communication restriction.

15. The apparatus of claim 14, wherein said applying at least one media communication restriction includes applying at least one carrier-level media communication restriction.

16. The apparatus of claim 14, wherein said applying at least one media communication restriction includes applying at least one user-level media communication restriction.

17. A method for restricting media communication in a wireless communication network, the method comprising:
receiving a request from a communication device for setting up a media communication session with at least one target;
applying at least one media communication restriction on the target; and
sending a media communication announcement to the target if the target is not restricted to receive media communication from the originator.

18. The method of claim 17, wherein said applying at least one media communication restriction includes applying at least one inbound media communication restriction.

19. The method of claim 18, wherein said applying at least one media communication restriction includes applying at least one carrier-level media communication restriction.

20. A computer-readable medium embodying codes for implementing a method for restricting media communication in a wireless communication network, the method comprising:
receiving a request from a communication device for setting up a media communication session with at least one target;
applying at least one media communication restriction on the target; and
sending a media communication announcement to the target if the target is not restricted to receive media communication from the originator.

21. The medium of claim 20, wherein said applying at least one media communication restriction includes applying at least one inbound media communication restriction.

22. The medium of claim 21, wherein said applying at least one media communication restriction includes applying at least one carrier-level media communication restriction.

23. An apparatus for restricting media communication in a wireless communication network, comprising:
means for receiving a request from a communication device for setting up a media communication session with at least one target;
means for applying at least one media communication restriction on the target; and
means for sending a media communication announcement to the target if the target is not restricted to receive media communication from the originator.

24. The apparatus of claim 23, wherein said means for applying at least one media communication restriction includes means for applying at least one inbound media communication restriction.

25. The apparatus of claim 24, wherein said means for applying at least one media communication restriction includes means for applying at least one carrier-level media communication restriction.

26. An apparatus for restricting media communication in a wireless communication network, comprising:
a memory unit;
a receiver;
a transmitter; and
a processor coupled to the memory unit, the receiver, and the transmitter, the processor being capable of:
receiving a request from a communication device for setting up a media communication session with at least one target;
applying at least one media communication restriction on the target; and
sending a media communication announcement to the target if the target is not restricted to receive media communication from the originator.

27. The apparatus of claim 26, wherein said applying at least one media communication restriction includes applying at least one inbound media communication restriction.

28. The apparatus of claim 27, wherein said applying at least one media communication restriction includes applying at least one carrier-level media communication restriction.

29. A method for restricting media communication in a wireless communication network, the method comprising:
receiving a media communication announcement for setting up a media communication session requested by an originator;
applying at least one media communication restriction on the originator; and
sending an acceptance for setting up the media communication if the originator is allowed to have media communication with the target.

30. The method of claim 29, wherein said applying at least one media communication restriction includes applying at least one inbound media communication restriction.

31. The method of claim 30, wherein said applying at least one media communication restriction includes applying at least one user-level media communication restriction.

32. A computer-readable medium embodying codes for implementing a method for restricting media communication in a wireless communication network, the method comprising:
receiving a media communication announcement for setting up a media communication session requested by an originator;
applying at least one media communication restriction on the originator; and
sending an acceptance for setting up the media communication if the originator is allowed to have media communication with the target.

33. The medium of claim 32, wherein said applying at least one media communication restriction includes applying at least one inbound media communication restriction.

34. The medium of claim 33, wherein said applying at least one media communication restriction includes applying at least one user-level media communication restriction.

35. An apparatus for restricting media communication in a wireless communication network, comprising:
means for receiving a media communication announcement for setting up a media communication session requested by an originator;
means for applying at least one media communication restriction on the originator; and
means for sending an acceptance for setting up the media communication if the originator is allowed to have media communication with the target.

36. The apparatus of claim 35, wherein said means for applying at least one media communication restriction includes means for applying at least one inbound media communication restriction.

37. The apparatus of claim 36, wherein said means for applying at least one media communication restriction includes means for applying a t least one user-level media communication restriction.

38. An apparatus for restricting media communication in a wireless communication network, comprising:
a memory unit;
a receiver;
a transmitter; and
a processor coupled to the memory unit, the receiver, and the transmitter, the processor being capable of:
receiving a media communication announcement for setting up a media communication session requested by an originator;
applying at least one media communication restriction on the originator; and
sending an acceptance for setting up the media communication if the originator is allowed to have media communication with the target.

39. The apparatus of claim 38, wherein said applying at least one media communication restriction includes applying at least one inbound media communication restriction.

40. The apparatus of claim 39, wherein said applying at least one media communication restriction includes applying at least one user-level media communication restriction.
